(19) United States
(12) Patent Application Publication
(10) Pub. No.: US 2013/0070943 A1
(43) Pub. Date: Mar. 21, 2013

(54) LOUDSPEAKER PROTECTION ASSEMBLY AND ELECTRONIC DEVICE WITH THE SAME

(71) Applicant: CHIH-WEI CHANG, Shindian (TW)

(72) Inventor: CHIH-WEI CHANG, Shindian (TW)

(73) Assignee: FIH (Hong Kong) LIMITED, Kowloon (HK)

(21) Appl. No.: 13/408,426

(22) Filed: Feb. 29, 2012

(30) Foreign Application Priority Data
Sep. 20, 2011 (CN) 201110279561.6

(51) Int. Cl. H04R 1/00; B32B 3/24

(52) U.S. Cl. 381/189; 428/138

(57) ABSTRACT

A loudspeaker protection assembly includes a foam layer defining a first through-hole, a magnetic layer defining a second through-hole, and a gauze layer fixed to the magnetic layer. The magnetic layer is fixed to the foam with the second through hole aligned with the first through-hole and attracts magnetic particles which might otherwise penetrate to the prejudice of the loudspeaker.

### BACKGROUND

1. Technical Field

The disclosure generally relates to loudspeaker protection assemblies and, particularly to loudspeaker protection assemblies for electronic devices.

2. Description of Related Art

Multi-function portable electronic devices need to be audio-capable. A portable electronic device may have a loudspeaker for implementing the multi-media playing function, and the loudspeaker is commonly received in a sound box of the portable electronic device. The sound box defines a plurality of holes for outputting audio sound waves created by vibration of the loudspeaker. However, the loudspeaker always includes a permanent magnetic element which may attract tiny magnetic particles and other debris in and around the sound box to the loudspeaker, adversely affecting the sound quality of the loudspeaker.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary loudspeaker protection assembly and electronic device with the loudspeaker protection assembly. Moreover, in the drawings, like reference numerals designate corresponding parts throughout the several views. Wherever possible, the same reference numbers are used throughout the drawings to refer to the same or like elements of an embodiment.

FIG. 1 is a schematic view of an embodiment of an electronic device with a sound box assembly according to present disclosure.

FIG. 2 is an exploded view of the electronic device of FIG. 1.

FIG. 3 is a cross sectional and enlarged view of the electronic device of FIG. 1 along a line of III-III.

FIG. 4 is similar to FIG. 3, but with a loudspeaker in place in the electronic device.

### DETAILED DESCRIPTION

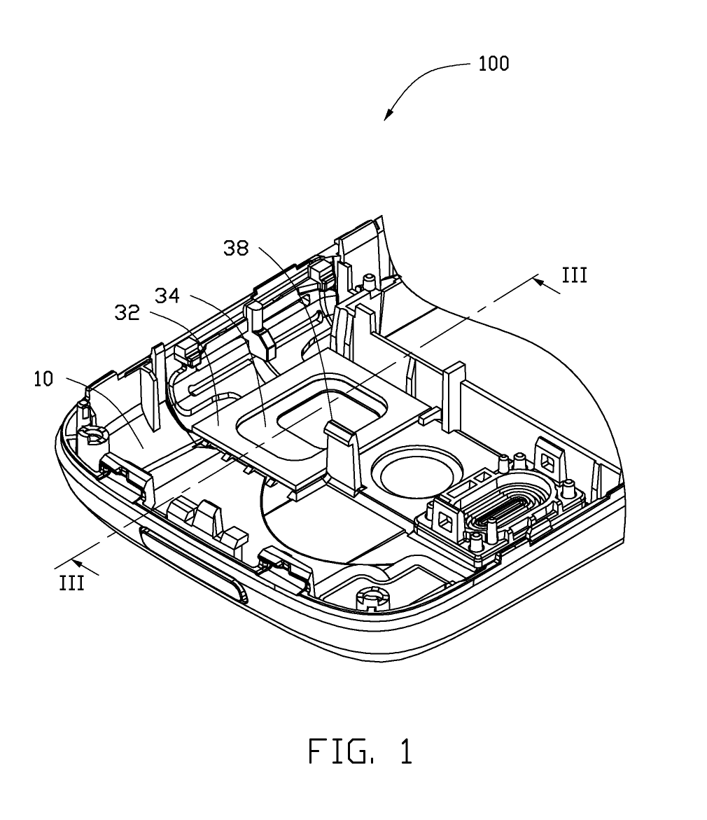

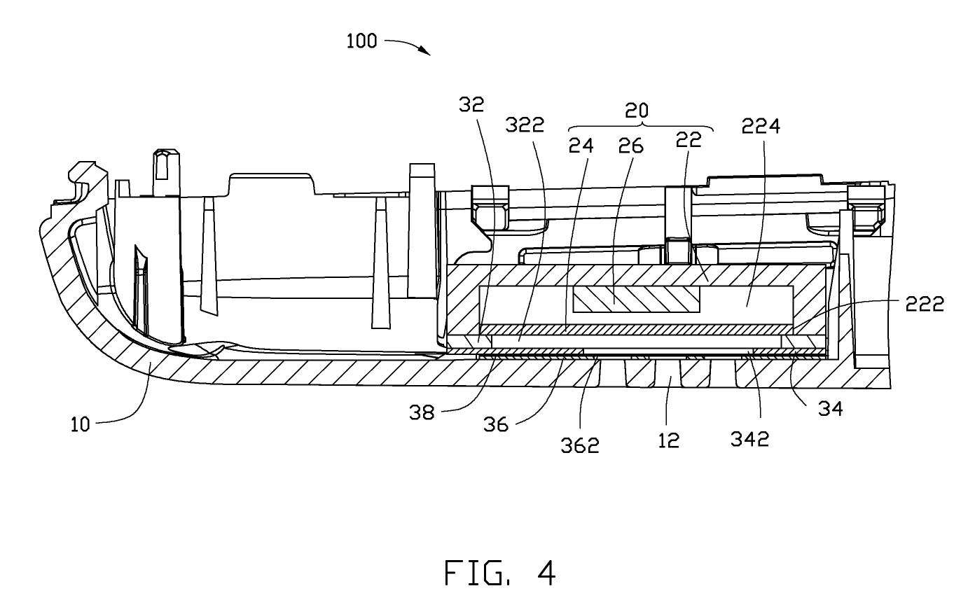

Referring to FIGS. 1, 2 and 4, an exemplary portable electronic device in the form of a mobile phone 100 includes a housing 10, a loudspeaker 20 (referring to FIG. 4) fixed to the housing 10, a loudspeaker protection assembly 30 secured by the housing 10 and the loudspeaker 20. The housing 10 defines a plurality of audio output holes 12 that allow the output of sound waves created by the loudspeaker 20.

Referring to FIG. 4, the loudspeaker 20 includes a main body 22, a vibration sheet 24 and a permanent magnet 26. The main body 22 is a frame defining an opening 222 which is covered by the vibration sheet 24, forming a chamber 224 in the main body 22. The permanent magnet 26 is fixed to the main body 22 in the chamber 224.

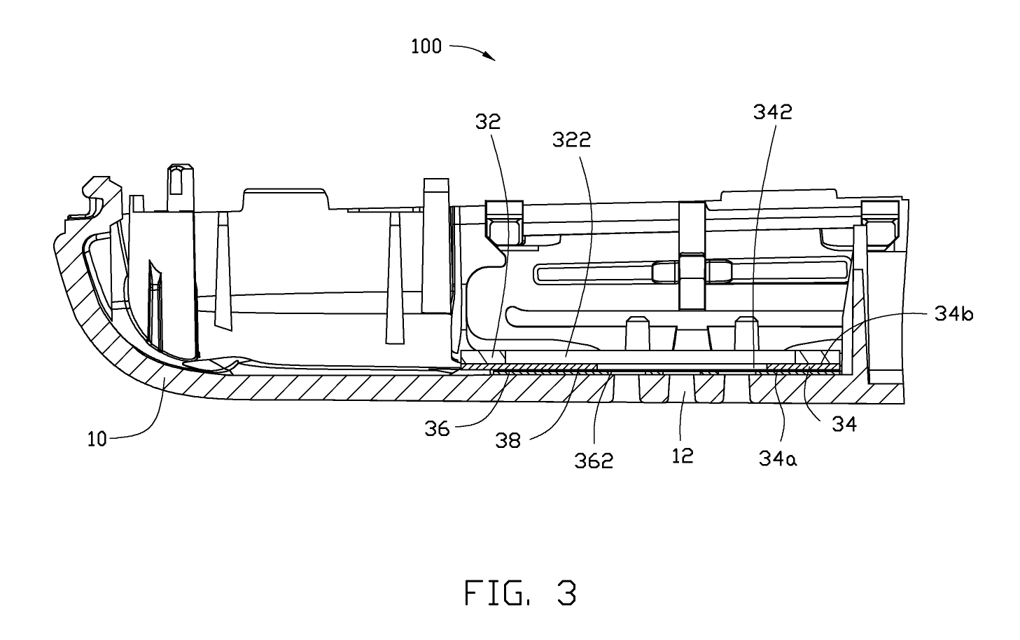

Referring to FIG. 3, the loudspeaker protection assembly 30 includes a foam layer 32, a magnetic layer 34, a shielding layer 36 and a gauze layer 38, all of which are laminated together. The magnetic layer has a first side 34a and a second side 34b, The first side 34a is attached to the shielding layer 36 and the second side 34b is attached to the foam layer 32. The foam layer 32 is made of soft foam, to seal any gap between the loudspeaker 20 and the housing 10. The foam layer 32 defines a first through-hole 322. The magnetic layer 34 is used to attract magnetically-vulnerable debris which may enter into the housing 10. The magnetic layer 34 defines a second through-hole 342 aligned with the first through-hole 322. The shielding layer 36 is made of metal to shield the magnetic field produced by the magnetic layer 34 and the magnetic field of the permanent magnet 26. The shielding layer 36 defines a plurality of third through-holes 362 aligned with and the first through-hole 322, the second through-hole 342. The gauze layer 38 prevents impurities such as dust from passing through the loudspeaker protection assembly 30. To facilitate output of the sound waves created by the loudspeaker, the gauze layer 38 defines a plurality of tiny openings.

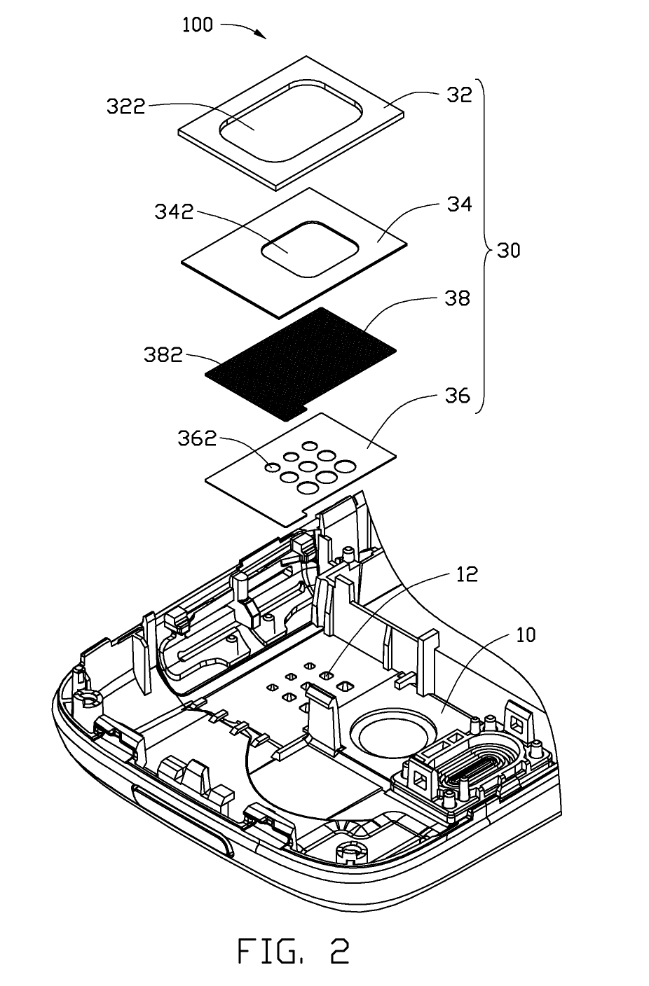

Referring to FIGS. 2-4, in assembly, the foam layer 32, the magnetic layer 34, the gauze layer 38 and the shielding layer 36 are laminated together. The shielding layer 36 is fixed to the housing 10 with the third through-holes 362 aligned with the audio output holes 12. The loudspeaker 20 is fixed to the housing 10 with the main body 22 fixed to the foam layer 32 and the vibration sheet 24 facing the first through-hole 322, to yield an assembled audio capability. In this situation, the magnetic layer 34 is between the permanent magnet 26 and the audio output holes 12.

When the mobile phone 100 is in an environment containing particles subject to magnetism, the magnetic layer 34 will attract any such particles which may enter into the audio output holes 12, thereby preventing the magnetic influence of the permanent magnet 26 on the particles and so avoiding any adverse effect on the sound quality of the loudspeaker 20.

It is to be understood, however, that even through numerous characteristics and advantages of the disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A loudspeaker protection assembly comprising:
a foam layer defining a first through-hole;
a magnetic layer having a first side and a second side and defining a second through-hole, the first side of the magnetic layer fixed to the foam with the second through hole aligned with the first through-hole;
a gauze layer fixed to the second side of the magnetic layer.

2. The loudspeaker protection assembly as claimed in claim 1, further comprising a shielding layer to shield a magnetic field produced by the magnetic layer.

3. The loudspeaker protection assembly as claimed in claim 2, wherein the shielding layer defines a third through-hole aligned with the first through-hole and the second through-hole.

4. An electronic device comprising:
a housing;
a loudspeaker fixed to the housing; and
a loudspeaker protection assembly latched by the housing and the loudspeaker, the loudspeaker protection assembly comprising:
a foam layer defining a first through-hole;
a magnetic layer having a first side and a second side and defining a second through-hole, the first side of the magnetic layer fixed to the foam with the second through hole aligned with the first through-hole;
a gauze layer fixed to the second side of the magnetic layer.

5. The electronic device as claimed in claim 4, further comprising a shielding layer to shield a magnetic field produced by the magnetic layer.

6. The electronic device as claimed in claim 5, wherein the shielding layer defines a third through-hole aligned with the first through-hole and the second through-hole.

7. An electronic device comprising:
a housing defining an audio output hole;
a loudspeaker fixed to the housing; and
a loudspeaker protection assembly latched by the housing and the loudspeaker, the loudspeaker protection assembly comprising:
a foam layer defining a first through-hole;
a magnetic layer having a first side and a second side and defining a second through-hole, the first side of the magnetic layer fixed to the foam with the second through hole aligned with the first through-hole;
a gauze layer fixed to the second side of the magnetic layer;
wherein the loudspeaker includes a permanent magnet, the magnetic layer is located between the permanent magnet and the audio output hole.

8. The electronic device as claimed in claim 7, further comprising a shielding layer to shield a magnetic field strength produced by the magnetic layer.

9. The electronic device as claimed in claim 8, wherein the shielding layer defines a third through-hole aligned with the first through-hole and the second through-hole.
